(19) United States
(12) Patent Application Publication
(10) Pub. No.: US 2019/0019093 A1
(43) Pub. Date: Jan. 17, 2019

(54) LP GAS CONSUMPTION PREDICTING DEVICE AND LP GAS CONSUMPTION PREDICTING METHOD

(71) Applicant: Azbil Kimmon Co., Ltd., Tokyo (JP)

(72) Inventor: Eiji MURAKAMI, Tokyo (JP)

(73) Assignee: Azbil Kimmon Co., Ltd., Tokyo (JP)

(21) Appl. No.: 16/025,426

(22) Filed: Jul. 2, 2018

(30) Foreign Application Priority Data
Jul. 12, 2017 (JP) 2017-136312

(51) Int. Cl. G06N 5/02

(52) U.S. Cl. CPC G06N 5/022

(57) ABSTRACT

An acquisition portion obtains the daily gas consumption amount of a tank from a gas meter. A consumption amount predicting portion predicts future daily gas consumption amounts for the set number of days using the latest gas consumption amount having the same day of the week among the gas consumption amounts obtained by the acquisition portion. A replacement day predicting portion, as a remaining amount predicting portion, predicts the remaining gas amount in the tank using the gas consumption amounts obtained by the acquisition portion and the future gas consumption amounts for the set number of days predicted by the consumption amount predicting portion.

### CROSS-REFERENCE TO RELATED APPLICATION

The present application claims the benefit of and priority to Japanese Patent Application No. 2017-136312, filed on Jul. 12, 2017, the entire contents of which are incorporated by reference herein.

### TECHNICAL FIELD

The present invention relates to a device that predicts the consumption of LP (Liquefied Petroleum) gas.

### BACKGROUND

There is a generally known LP gas supply system in which gas in a container is supplied to a gas meter through a pipe and then supplied to a terminal gas combustion chamber through a pipe from the gas meter as described in, for example, PTL 1. In the LP gas supply system described in PTL 1, the amount of gas consumption is integrated by a flow rate sensor provided in the gas meter and the integrated value is reported as a read value to an information center at a predetermined date and time. In many cases, the read value is reported once a month.

### CITATION LIST

### Patent Literature

[PTL 1] Japanese Patent No. 3525404

### SUMMARY

Before an LP gas tank becomes empty, the tank needs to be replaced with another new one filled with gas. However, when the amount of gas consumption is reported once a month as conventionally, the prediction of the remaining amount is difficult. Although a call is sent to the information center each time the remaining amount becomes lower than the remaining amount alert level in PTL 1 above, the prediction of the remaining amount is not performed.

The invention addresses the above problem with an object of obtaining an LP gas consumption predicting device capable of predicting the remaining amount in an LP gas tank.

An LP gas consumption predicting device according to the invention comprises an acquisition portion that obtains daily gas consumption amounts; a consumption amount predicting portion that predicts future daily gas consumption amounts for a set number of days using the latest gas consumption amount of the same day of the week among the gas consumption amounts obtained by the acquisition portion; and a remaining amount predicting portion that predicts the remaining gas amount in a tank using the gas consumption amounts obtained by the acquisition portion and the future gas consumption amounts for the set number of days predicted by the consumption amount predicting portion.

According to the invention, the remaining amount in an LP gas tank can be predicted by predicting future daily gas consumption amounts for the set number of days using the latest gas consumption amount of the same day of the week among the obtained gas consumption amounts.

### BRIEF DESCRIPTION OF THE DRAWINGS

FIG. 1 is a block diagram illustrating the structure of a consumption predicting device according to embodiment 1.

FIG. 2 is a flowchart illustrating an example of processing by the consumption predicting device according to embodiment 1.

FIGS. 3 and 4 are tables used to describe prediction processing by the consumption predicting device according to embodiment 1 using specific values.

FIG. 5 illustrates a linear regression model that represents the relationship between the number of elapsed days, the day of the week, and the remaining gas amount in the tank.

FIG. 6 illustrates a nonlinear regression model that represents the relationship between the number of elapsed days, the day of the week, and the remaining gas amount in the tank.

### DETAILED DESCRIPTION

### Embodiment 1

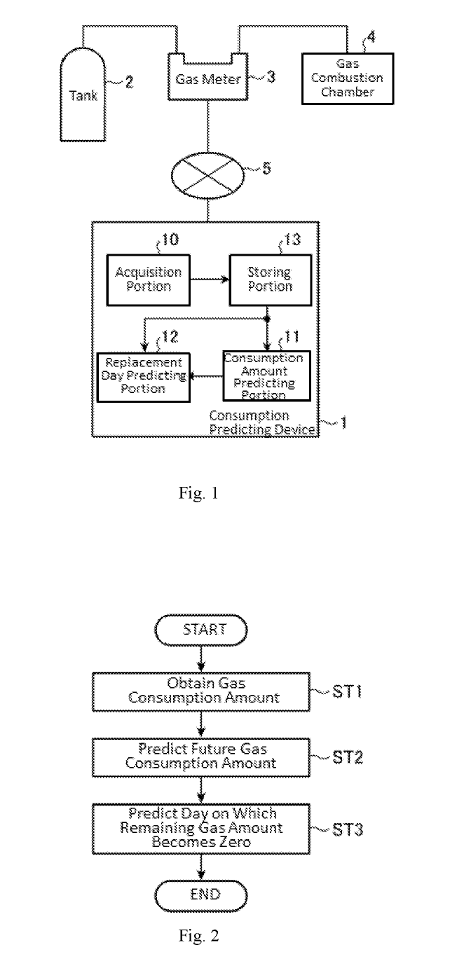

FIG. 1 is a block diagram illustrating the structure of an LP gas (also, simply referred to below as gas) consumption predicting device 1 according to embodiment 1. FIG. 1 also illustrates an LP gas tank 2, a gas meter 3, a gas combustion chamber 4, a communication line 5, and the like.

The gas in the tank 2 is supplied to the gas combustion chamber 4 via the gas meter 3. The gas meter 3 measures the amount of gas flowing out of the tank 2 and transmits the gas consumption amount to the consumption predicting device 1 via the communication line 5.

The gas combustion chamber 4 is, for example, a gas cooking stove, a gas water heater, or a gas stove.

Although the number of the gas meters 3 connected to the consumption predicting device 1 via the communication line 5 and the number of the tanks 2 to be measured by the gas meter 3 may be two or more, only one tank 2 and only one gas meter 3 are illustrated in FIG. 1 to simplify the description.

The consumption predicting device 1 comprises an acquisition portion 10, a consumption amount predicting portion 11, a replacement day predicting portion 12, and a storing portion 13. The consumption predicting device 1 is constructed in a server managed by a gas supply operator or the like. This server is communicably connected to the gas meter 3 via the communication line 5.

The acquisition portion 10 obtains the daily gas consumption amount of the tank 2 from the gas meter 3 via the communication line 5. It should be noted here that the acquisition portion 10 may receive the gas consumption amount of one day from the gas meter 3 once a day or may receive the gas consumption amount of substantially one day by receiving the gas consumption amount at shorter intervals (for example, at intervals of one hour) from the gas meter 3 and summarizing the amounts of one day. That is, the gas meter 3 is configured to transmit information indicating the daily gas consumption amount. After obtaining the daily gas consumption amount, the acquisition portion 10 accumulates the gas consumption amounts in the storing portion 13.

The storing portion 13 can be accessed by the acquisition portion 10, the consumption amount predicting portion 11, and the replacement day predicting portion 12. In addition, the storing portion 13 stores information about the tank 2 such as the day on which the previous tank was replaced with the tank 2 (that is, the use start day of the tank 2), the capacity of the tank 2, and the installation place of the tank 2.

The consumption amount predicting portion 11 predicts the future gas consumption amount daily. At this time, the consumption amount predicting portion 11 performs prediction using the latest gas consumption amount of the same day of the week that needs to be predicted among the gas consumption amounts obtained by the acquisition portion 10. The prediction method for the gas consumption amount by the consumption amount predicting portion 11 will be described in detail later. The consumption amount predicting portion 11 outputs the predicted future gas consumption amount to the replacement day predicting portion 12.

The replacement day predicting portion 12 predicts the remaining gas amount in the tank 2 and the day on which the remaining gas amount in the tank 2 becomes zero, that is the replacement day, based on the gas consumption amount obtained by the acquisition portion 10 and the future gas consumption amount predicted by the consumption amount predicting portion 11.

The consumption predicting device 1 comprises a communication device, a memory, a processor, and the like and the processing of each portion of the acquisition portion 10, the consumption amount predicting portion 11, and the replacement day predicting portion 12 is performed by causing the processor to execute programs stored in the memory. It should be noted here that a plurality of processors and a plurality of memories may be combined with each other.

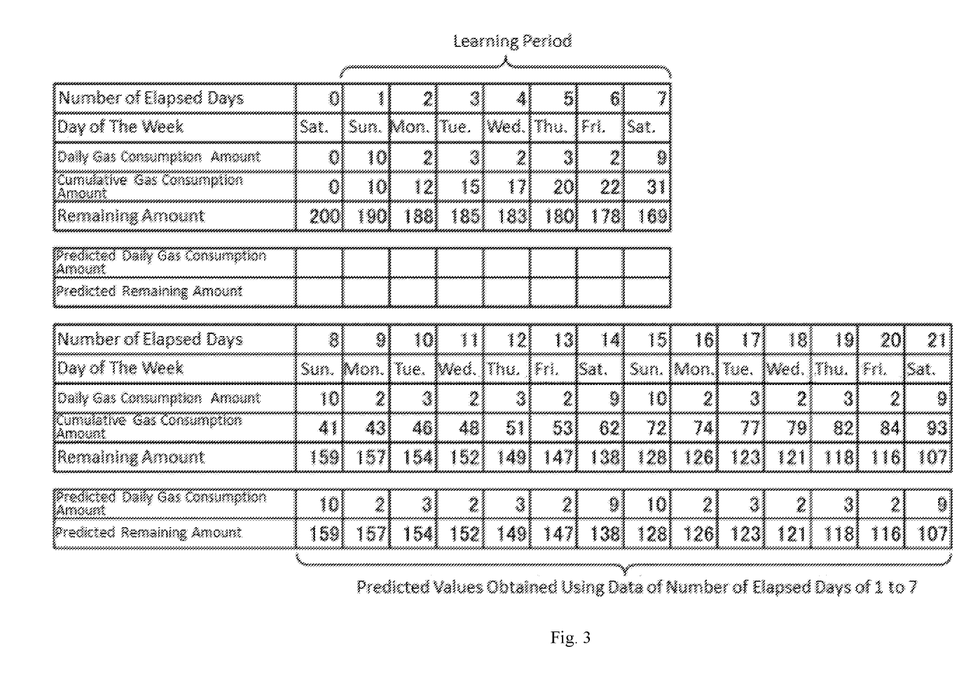

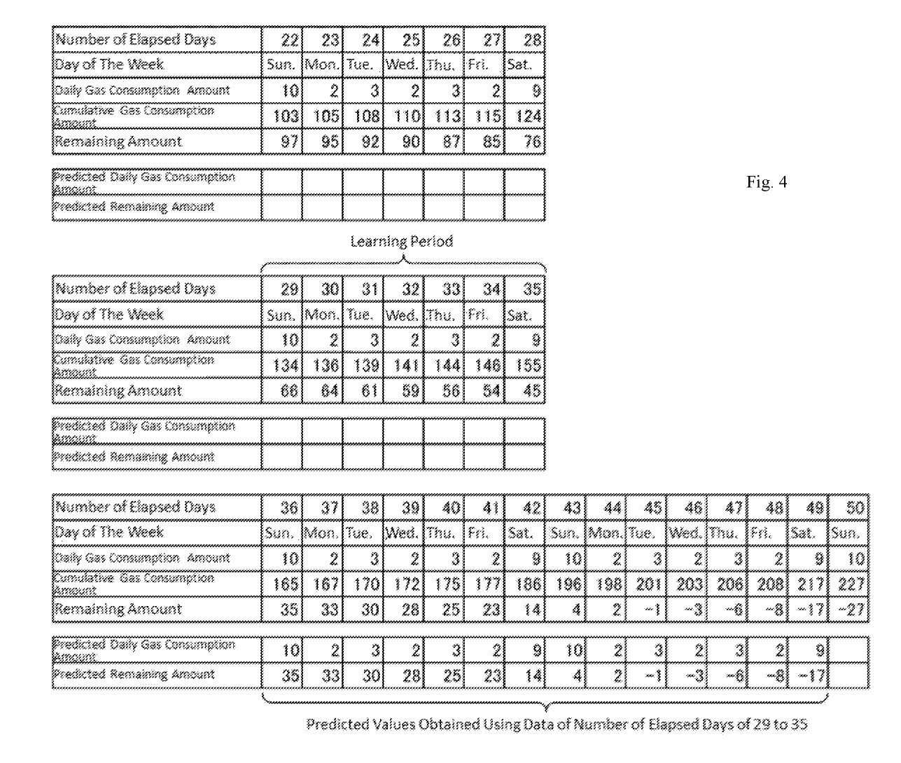

Next, an example of processing by the consumption predicting device 1 configured as described above will be described with reference to the flowchart illustrated in FIG. 2 and the table illustrated in FIGS. 3 and 4.

The acquisition portion 10 obtains the daily gas consumption amount of the tank 2 from the gas meter 3 via the communication line 5 (step ST1). The obtained gas consumption amount is associated with information of the day of the week, and the like, and accumulated in the storing portion 13.

Next, the consumption amount predicting portion 11 predicts the future daily gas consumption amount for the set number of days based on the gas consumption amount obtained and accumulated in the storing portion 13 by the acquisition portion 10 (step ST2). The predicted gas consumption amount is output to the replacement day predicting portion 12.

FIGS. 3 and 4 illustrate tables used to describe prediction processing by the consumption predicting device 1 using specific values.

The following description assumes that the remaining amount in the tank 2 for the number of elapsed days of 0 is 200 (that is, the capacity of the tank 2 is 200 liters). The number of elapsed days represents the number of days elapsed after the use of the tank 2 is started.

As illustrated in FIG. 3, it is assumed that the gas consumption amounts of the number of elapsed days of 1 to the numbers of elapsed days of 7 are 10 liters, 2 liters, 3 liters, 2 liters, 3 liters, 2 liters, and 9 liters, respectively. The day that corresponds to the number of elapsed days of 1 is a Sunday and the day that corresponds to the number of elapsed days of 7 is a Saturday.

The consumption amount predicting portion 11 starts predicting the future daily gas consumption amounts for the set number of days for the tank 2 when the gas consumption amounts of at least a Monday to a Sunday are all obtained. The set number of days is determined based on “the number of days that needs to be predicted” that has been preset. For example, the set number of days may be set to the number of days that needs to be predicted as is or may be set to the number of days that needs to be predicted plus several days. The following description assumes that the number of days that needs to be predicted is one week and the set number of days is twice the number of days that needs to be predicted.

When the gas consumption amounts of up to the number of elapsed days of 7 measured by the gas meter 3 are obtained by the acquisition portion 10, the consumption amount predicting portion 11 daily predicts the future gas consumption amounts for two weeks that are the set number of days, that is, the gas consumption amounts on the number of elapsed days of 8 to the number of elapsed days of 21. At this time, the consumption amount predicting portion 11 performs prediction on the assumption that the same gas consumption as the latest gas consumption on the same day of the week among the gas consumption amounts obtained by the acquisition portion 10 occurs. This is because gas consumption behaviors generally depend on the day of the week.

For example, since the day that corresponds to the number of elapsed days of 8 is a Sunday, a gas consumption amount of 10 liters on the day corresponding to the number of elapsed days of 1 obtained latest as the gas consumption amount on a Sunday is predicted as the gas consumption amount on the number of elapsed days of 8.

Similarly, since the day corresponding to the number of elapsed days of 9 is a Monday, a gas consumption amount of 2 liters on the day corresponding to the number of elapsed days of 2 obtained latest as the gas consumption amount on a Monday is predicted as the gas consumption amount on the number of elapsed days of 9.

This is also true of the number of elapsed days of 10 to the number of elapsed days of 21, so the daily gas consumption amounts on the number of elapsed days of 8 to the number of elapsed days of 21 are predicted using the number of elapsed days of 1 to the number of elapsed days of 7 as the learning period.

Such prediction is performed each time the acquisition portion 10 newly obtains the daily gas consumption amount. That is, when the gas consumption amount on that day is transmitted from the gas meter 3 at the number of elapsed days of 8, the consumption amount predicting portion 11 predicts the gas consumption amounts on the number of elapsed days of 9 to the number of elapsed days of 22 using the gas consumption amounts from the number of elapsed days of 2 to the number of elapsed days of 8. In this way, each time the acquisition portion 10 newly obtains the daily gas consumption amount, the predicted value is updated.

The replacement day predicting portion 12 predicts the day on which the remaining gas amount in the tank 2 becomes zero using the gas consumption amount obtained by the acquisition portion 10 and the future gas consumption amounts for the set number of days predicted by the consumption amount predicting portion 11 (step ST3).

The replacement day predicting portion 12 can predict the daily remaining gas amounts for the set number of days by subtracting the cumulative value of the gas consumption amounts obtained thus far by the acquisition portion 10 and subtracting the predicted values of the gas consumption amounts for the set number of days predicted by the consumption amount predicting portion 11 from the capacity of the tank 2. As described above, the replacement day predicting portion 12 functions as the remaining amount predicting portion that predicts the future remaining gas amounts for the set number of days. When the replacement day predicting portion 12 predicts that the remaining gas amount becomes zero on some day of the set number of days by receiving the prediction by the remaining amount predicting portion, the replacement day predicting portion 12 outputs the predicted day on which the remaining gas amount becomes zero as the processing result.

In the example in FIG. 4, when the gas consumption amounts of the number of elapsed days of 36 to the number of elapsed days of 49 are predicted using the gas consumption amounts of the number of elapsed days 29 to the number of elapsed days of 35, the remaining gas amount is predicted to become zero when the number of elapsed days is 45.

As described above, the consumption predicting device 1 can accurately predict the future gas consumption amounts and the remaining amount and the replacement day of the tank 2 by obtaining the daily gas consumption amounts from the gas meter 3.

The prediction method described above is so-called heuristics prediction. However, heuristics prediction is apt to become inaccurate when the learning period includes exceptional days, such as Golden Week holidays or year-end and New Year holidays. Accordingly, the consumption predicting device 1 may perform prediction using a combination with a linear regression model or a nonlinear regression model instead of using only heuristics prediction.

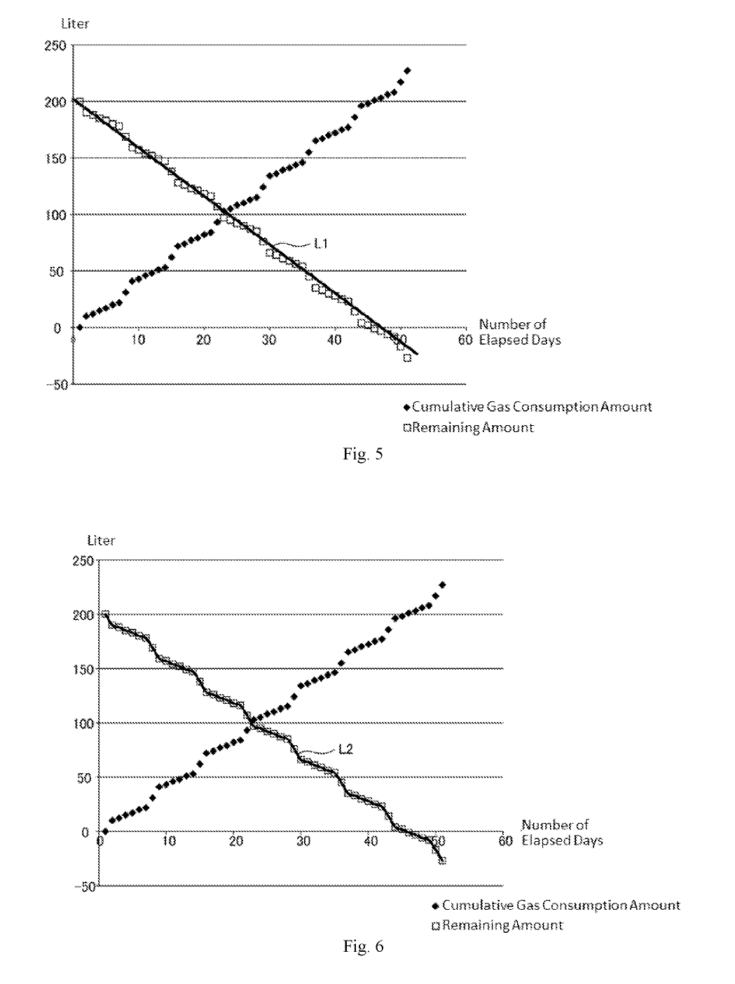

First, a prediction method using a combination with a linear regression model will be described. This linear regression model represents the relationship between the number of elapsed days, the day of the week, and the remaining gas amount in the tank as expression (1) below. When the values illustrated in FIGS. 3 and 4 are used as the target, modeling is performed as a straight line L1 illustrated in FIG. 5. It should be noted here that FIG. 5 also indicates the cumulative gas consumption amount. In addition, the section in which the remaining amount is approximately 0 and negative in FIG. 5 is an extrapolation section.

Y=β₀+β₁X₁+β₂X₂+ . . . +βₚXₚ+ε (1)

In expression (1), Y represents the remaining amount, X₁ to Xₚ represent the number of elapsed days, β₁ to βₚ each represents information (e.g., consumption) of the day of the week that has been converted into a dummy variable, and ε represents a starting gas amount in the tank.

When the replacement day predicting portion 12, as the remaining amount predicting portion, predicts the remaining amount, if the gas consumption amount used for prediction by the consumption amount predicting portion 11 of the gas consumption amounts obtained by the acquisition portion 10 is the gas consumption amount of an exceptional day (that is, if the learning period includes an exceptional day), the replacement day predicting portion 12 corrects the remaining amount of the predicted day using the gas consumption amount of the exceptional day. The correction is performed using a linear regression model as described above, which can perform calculation based on the daily gas consumption amounts of, for example, the previous month. It should be noted here that the linear regression model used for correction is not limited to one that is based on the gas consumption of the previous month and only needs to be based on the gas consumption in a past period, so the linear regression model may be, for example, one that is based on the gas consumption of the month before the previous month as well as the previous month or one that is based on the gas consumption from when use of the tank was last started to when the tank was replaced.

For example, it is assumed that, when the replacement day predicting portion 12, as the remaining amount predicting portion, calculates the future daily remaining amounts for the set number of days using the gas consumption amounts predicted by the consumption amount predicting portion 11, the remaining amount on a Thursday, two days later, is R1, but the Thursday in the learning period is an exceptional day. In this case, the replacement day predicting portion 12, as the remaining amount predicting portion, separately calculates the remaining amount of a prediction target day D that is the Thursday, two days later, for which the remaining amount has been calculated to R1 using the linear regression model described above. It should be noted here that the prediction target day represents the day for which the consumption predicting device 1 performs prediction and means each of the future days corresponding to the set number of days.

When the remaining amount of the prediction target day D separately calculated using a linear regression model is assumed to be R2, the replacement day predicting portion 12 performs weighting as illustrated in expression (2) and calculates a correction value R of the remaining amount as the remaining amount predicting portion. Then, the remaining amount of the Thursday, two days later, is assumed to be the correction value R and the daily remaining amounts after the Thursday, two days later, are calculated.

R=aR1+bR2 (2)

It should be noted here that the total value of a and b equals 1.

Next, a predication method using a combination with a nonlinear regression model will be described. The nonlinear regression model represents the relationship between the number of elapsed days, the day of the week, and the remaining gas amount in the tank as expression (3) below. When the values illustrated in FIGS. 3 and 4 are used for learning, modeling is performed as a curve L2 illustrated in FIG. 6. It should be noted here that FIG. 6 also illustrates the cumulative gas consumption amount. In addition, the section in which the remaining amount is approximately 0 and negative in FIG. 6 is an extrapolation section.

y=f(x,β) (3)

In expression (3), y is a vector indicating the remaining amount, x is a vector indicating the number of elapsed days, and β indicates information of the day of the week.

When the replacement day predicting portion 12, as the remaining amount predicting portion, predicts the remaining amount, the replacement day predicting portion 12 compares a current gas remaining amount R3 calculated by subtracting, from the capacity of the tank 2, the cumulative value of the gas consumption amount obtained by the acquisition portion 10 from the gas meter 3 with a current gas remaining amount R4 separately calculated using a nonlinear regression model between the number of elapsed days, the day of the week, and the gas remaining amount in the tank. The nonlinear regression model is calculated based on, for example, the daily gas consumption amounts of the previous month. It should be noted here that the nonlinear regression model is not limited to one that is based on the gas consumption of the previous month and only needs to be based on the gas consumption in a past period, so the nonlinear regression model may be, for example, one that is based on the gas consumption of the month before the previous month as well as the previous month or one that is based on the gas consumption from when use of the tank was last started to when the tank was replaced.

As a result of the comparison, when the remaining amount R3 is smaller than the remaining amount R4 and the remaining gas amount is reduced at higher speed than in a past period such as the previous month, the replacement day predicting portion 12 predicts the day on which the remaining amount becomes zero by performing correction that reduces the remaining amount as the remaining amount predicting portion by, for example, subtracting a certain value evenly from the remaining amounts of the prediction target days calculated using the gas consumption amounts predicted by the consumption amount predicting portion 11.

Alternatively, as a result of the comparison, when the remaining amount R3 is larger than the remaining amount R4 and the +++ remaining gas amount is reduced at lower speed than in a past period such as the previous month, the replacement day predicting portion 12 predicts the day on which the remaining amount becomes zero by performing correction that increases the remaining amount as the remaining amount predicting portion by, for example, adding a certain value evenly to the remaining amounts of the prediction target days calculated using the gas consumption amounts predicted by the consumption amount predicting portion 11.

When the consumption predicting device 1 performs prediction using a combination with a linear regression model or a nonlinear regression model, the prediction reliability can be improved.

In the above description, the consumption predicting device 1 is assumed to be constructed in a server managed by a gas supply operator or the like. However, when, for example, the memory capacity of the gas meter 3 is large, the consumption predicting device 1 may be constructed in the gas meter 3 and the remaining gas amount or the day on which the remaining amount is predicted to become zero may be reported to the server managed by a gas supply operator or the like.

In addition, when the consumption predicting device 1 is used only to predict the remaining gas amount, the replacement day predicting portion 12 only needs to function as a remaining amount predicting portion that predicts the future remaining gas amounts for the set number of days and does not need to predict the replacement day.

As described above, according to embodiment 1, the consumption amount predicting portion 11 predicts future gas consumption amounts daily by using the latest gas consumption amount of the same day of the week among the daily gas consumption amounts obtained by the acquisition portion 10. Then, the replacement day predicting portion 12, as the remaining amount predicting portion, predicts the remaining gas amount in the tank 2 using the predicted gas consumption amount. Since gas consumption behaviors depend on the day of the week, prediction in consideration of the day of the week as in embodiment 1 can provide reliable prediction results.

In addition, prediction of the day on which the remaining gas amount becomes zero by the replacement day predicting portion 12 causes a gas supply operator or the like to easily grasp the replacement day of the tank.

When the gas consumption amount used for prediction by the consumption amount predicting portion 11 among the gas consumption amounts obtained by the acquisition portion 10 is the gas consumption amount of an exceptional day, the replacement day predicting portion 12, as the remaining amount predicting portion, corrects the remaining gas amount of the prediction target day having the same day of the week as the exceptional day using a linear regression model between the number of elapsed days, the day of the week, and the remaining gas amount in the tank in a past period. This can improve the reliability of prediction.

In addition, the replacement day predicting portion 12, as the remaining amount predicting portion, makes comparison with a nonlinear regression model between the number of elapsed days, the day of the week, and the remaining gas amount in the tank in a past period. Then, the replacement day predicting portion 12 makes correction so as to reduce the remaining gas amount of the prediction target day when the remaining gas amount is reduced at higher speeds than in the past period or makes correction so as to increase the remaining gas amount of the prediction target day when the remaining gas amount is reduced at lower speeds than in the past period. This can improve the reliability of prediction.

In addition, the consumption predicting device 1 is provided in a server communicably connected to the gas meter 3 that measures the amount of gas flowing out of the tank 2. This can centrally manage the day on which the tank of LP gas is replaced on the server.

It should be noted here that any component of the embodiment can be modified or any component of the embodiment can be omitted within the scope of the invention.

### DESCRIPTION OF REFERENCE NUMERALS AND SIGNS

1: consumption predicting device

2: tank

3: gas meter

4: gas combustion chamber

5: communication line

10: acquisition portion

11: consumption amount predicting portion

12: replacement day predicting portion

13: storing portion

1. A Liquefied Petroleum (LP) gas consumption predicting device, comprising:
an acquisition portion that obtains daily gas consumption amounts (from a gas consumption measuring device);
a consumption amount predicting portion that predicts future daily gas consumption amounts for a set number of days using a corresponding one or more latest gas consumption amounts of one or more same days of a week among the gas consumption amounts obtained by the acquisition portion; and
a remaining amount predicting portion that predicts a remaining gas amount in a tank using the daily gas consumption amounts obtained by the acquisition portion and the future daily gas consumption amounts predicted by the consumption amount predicting portion.

2. The LP gas consumption predicting device according to claim 1, further comprising:
a replacement day predicting portion that predicts a day on which the remaining gas amount in the tank becomes zero by receiving one or more predictions performed by the remaining amount predicting portion.

3. The LP gas consumption predicting device according to claim 2,
wherein, when the one or more latest gas consumption amounts used for prediction by the consumption amount predicting portion among the daily gas consumption amounts obtained by the acquisition portion includes a gas consumption amount of an exceptional day, the remaining amount predicting portion corrects the remaining gas amount of a prediction target day having a same day of the week as the exceptional day using a linear regression model between a number of elapsed days, one or more days of the week, and the remaining gas amount in the tank in a past period.

4. The LP gas consumption predicting device according to claim 2,
wherein the remaining amount predicting portion:
makes comparison with a nonlinear regression model between a number of elapsed days, one or more days of the week, and the remaining gas amount in the tank in a past period, and
makes correction so as to reduce the remaining gas amount of a prediction target day when the remaining gas amount is reduced at higher speeds than in the past period or makes correction so as to increase the remaining gas amount of the prediction target day when the remaining gas amount is reduced at lower speeds than in the past period.

5. The LP gas consumption predicting device according to claim 1,
wherein, when the one or more latest gas consumption amounts used for prediction by the consumption amount predicting portion among the daily gas consumption amounts obtained by the acquisition portion includes a gas consumption amount of an exceptional day, the remaining amount predicting portion corrects the remaining gas amount of a prediction target day having a same day of the week as the exceptional day using a linear regression model between a number of elapsed days, one or more days of the week, and the remaining gas amount in the tank in a past period.

6. The LP gas consumption predicting device according to claim 1,
wherein the remaining amount predicting portion:
makes comparison with a nonlinear regression model between a number of elapsed days, one or more days of the week, and the remaining gas amount in the tank in a past period, and
makes correction so as to reduce the remaining gas amount of a prediction target day when the remaining gas amount is reduced at higher speeds than in the past period or makes correction so as to increase the remaining gas amount of the prediction target day when the remaining gas amount is reduced at lower speeds than in the past period.

7. The LP gas consumption predicting device according to claim 1, wherein the LP gas consumption predicting device is provided in a server communicably connected to a gas meter (as the gas consumption measuring device) that measures a gas amount flowing out of a tank.

8. A Liquefied Petroleum (LP) gas consumption predicting method, comprising:
obtaining, by an acquisition portion, daily gas consumption amounts;
predicting, by a consumption amount predicting portion, future daily gas consumption amounts for a set number of days using a corresponding one or more latest gas consumption amounts of one or more same days of a week among the gas consumption amounts obtained in the obtaining step; and
predicting, by a remaining amount predicting portion, a remaining gas amount in a tank using the daily gas consumption amounts obtained in the obtaining step and the future daily gas consumption amounts for the set number of days predicted in the consumption amount predicting step.
